(19) United States
(12) Patent Application Publication
(10) Pub. No.: US 2009/0204883 A1
(43) Pub. Date: Aug. 13, 2009

(54) Method, Program and System for the Dynamic, Template-Based Generation of Internet Pages

(76) Inventors: Thomas Talanis, Heroldsbach (DE); Thomas Tröster, Dittenheim (DE); Frank Volkmann, Nürnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/658,904

(22) PCT Filed: Jul. 21, 2005
(86) PCT No.: PCT/EP2005/053548

§ 371 Date: Jan. 30, 2007

(30) Foreign Application Priority Data
Jul. 30, 2004 (DE) 10 2004 036 976.3

(51) Int. Cl. G06F 17/00

(52) U.S. Cl. 715/234

(57) ABSTRACT

There is described a method for the dynamic generation of internet pages, a computer program and a computer system for carrying out said method. Internet pages are thus mostly generated when requested by a client. Script languages such as ASP or PHP are used which have a high demand for hardware resources. Computer systems with limited hardware resources, in particular, integrated systems cannot however make use of the above. A flexible and resource-saving generation of internet pages has to be achieved. Said aim is achieved by means of preparing a static internet page for the client and to prepare an add-on for the variable content components. The add-on piece is generated with a standard parser, a data file and a template. The static internet page links to the data file and this to the template. Alternatively the static internet page links to both the data file and the template.

### CROSS REFERENCE TO RELATED APPLICATIONS

This application is the US National Stage of International Application No. PCT/EP2005/053548, filed Jul. 21, 2005 and claims the benefit thereof. The International Application claims the benefits of German application No. 10 2004 036 976.3 DE filed Jul. 30, 2004, both of the applications are incorporated by reference herein in their entirety.

### FIELD OF INVENTION

The invention relates to a method for generating internet pages, a computer program implementing the method and a computer system realizing the method according to the preambles of the independent claims. The invention can hereby be used in particular with integrated systems (embedded systems).

### BACKGROUND OF INVENTION

Servers provide Internet pages on the Internet and transmit them to clients. In this process it is standard for the Internet pages to be generated dynamically, in other words only generated when requested by the client. This means that different browsers can be supported for example and current information can also be embedded in the respective Internet page.

The dynamic generation of Internet pages is carried out by means of known script languages, using ASP/ASP-net (active server pages) from Microsoft for example or using the open source script language PHP. PHP here is a recursive acronym, standing for “PHP Hypertext Preprocessor”. The Internet pages are hereby generated by executing scripts. The provision of a programming environment using one of the current script languages is complex and requires a large number of resources on the part of the hardware. The scripts used also have to be encapsulated in a complex operation, in order not to influence the stability of the server in a negative manner. If the servers are standard computers, this resource requirement is generally easy to meet. In this instance a script language offers many possibilities for generating Internet pages in a flexible manner.

If however the available resources of the server are more modest, for example because the microprocessor is less powerful or the server is equipped with little main memory or little or no hard disk storage, such script languages cannot be used. This situation arises in particular with integrated or embedded systems, as used frequently in the field of automation. Integrated or embedded systems are optimized to minimize costs and use a generally simplified hardware structure with slow processors with little memory, the hardware being intended to operate as reliably as possible. Such integrated systems can therefore not provide the resources required for a script language. So that integrated systems can still generate Internet pages dynamically, the dynamic elements have hitherto been stored in the firmware. This means that it is not possible to make subsequent changes to the dynamic elements and customer-specific tailoring of the Internet pages for example is not possible.

A system and method for embedding dynamic content in Internet pages are known from U.S. Pat. No. 5,987,480 A1. A template can be selected with the aid of a script implemented in a programming language, said template describing the layout of the Internet page and containing links to a data source, the data of which replaces certain variables serving as placeholders within the template.

An “include” instruction is known from XP-002956744 “NCSA http server side includes”, which allows text to be inserted from a first document into a second parked document.

### SUMMARY OF INVENTION

In one aspect the invention is based on the technical problem of allowing the dynamic generation of Internet pages with only a small hardware resource requirement.

This technical problem is resolved by the features of the independent claims. Advantageous developments are set out in the features of the dependent claims or will emerge from the description.

According to the invention it has been identified that the method-related aspect of the above-mentioned technical problem can be resolved by generating Internet pages by first providing a basic Internet page comprising static code. There are two possibilities:
a) First there is the possibility of the basic Internet page linking to at least one data file and the data file in turn to at least one template. In this instance the basic Internet page is supplemented by parsing the data file, with the link meaning that the template is also parsed at least once, and the output of the parsing process supplementing the above-mentioned static basic Internet page as a dynamic element.
b) Alternatively or in addition to the above-mentioned possibility, it is also possible for the basic Internet page to link both to a data file and a template. In this instance the basic Internet page is supplemented by parsing the data file and template separately with the common output of the parsing processes supplementing the above-mentioned static basic Internet page as a dynamic element.

The above-mentioned technical problem is also resolved by a computer product, which can be used to execute the above-mentioned method on a computer system. It is also proposed that a computer system should be provided, which is configured to implement the above-mentioned method.

The inventive method is used for the dynamic generation of Internet pages. Dynamic generation of Internet pages refers in the context of the description in the present invention to the fact that generation only takes place when the Internet page has been requested by a third party. This third party is a second computer or client, which is provided with Internet pages by the first computer or the server.

In a first step a basic Internet page is prepared from a static code. A static code, for example in the form of an ASCII file, refers to a code, which remains unmodified for quite a long time and which leads to ever-recurring elements of the Internet page. The static element can define the layout of the Internet page or its color configuration can reflect the corporate identity of the company. In contrast to this is the dynamic code, which is modified much more frequently than the static code and which is used for example to provide customer-specific or up to date information on the Internet page, in some instances every second. A further example of dynamic code is advertising banners, which frequently appear on Internet pages.

The basic Internet page can be provided by storing the basic Internet page in a storage module of the computer system, for example an EPROM or ASIC, and retrieving it from there. It is however also possible for provision to comprise the first generation of the basic Internet page by means of a suitable program.

The basic Internet page can be a text file and has at least one link to at least one data file. In a first variant the data file in turn has at least one link to at least one template. A parser is used to generate an add-on to the basic Internet page by means of the data file and the template. The basic Internet file and the add-on are sent to the client and are displayed there by the browser as a single Internet page on the screen surface.

The add-on is hereby generated as follows: the parser parses the basic Internet page and finds a link to the data file there. The syntax of this link is “ProcessData (Filename, Templatename)”, “Filename” being the name of the data file and “Templatename” being the name of the template. It can be seen from this that the basic Internet page also links to the template. To generate the add-on, the data file is parsed, then the part of the basic Internet page below the link to the data file. Depending on the number of links, this process is repeated, until the whole basic Internet page has been parsed. During the parsing process the parser checks the syntax of the data file and generates an output, which is stored in an (output) buffer or in the main memory. The output can of course also be effected on a data medium and thus for example on a hard disk.

Within the data file there is at least one link to at least one template. When the parser reaches the link point, the linked template is parsed. The parser essentially generates an output in this process, by copying lines of the template to the buffer. If the template has variable structures, the parser replaces the variable structures with their values. These values can hereby be predetermined generally or stored in the data file.

In a second variant the basic Internet page links to a data file and a template. A separate parser entity is called up at each link point. Depending on the location of the link point within the basic Internet page and the computer architecture used, the separate parser entities follow each other in time or are (almost) temporally parallel. The common output of the parser entities is then the dynamic add-on to the basic Internet page.

The proposed method has the advantage that Internet pages can be generated dynamically and that flexible working is hereby made possible in respect of the content of the data file in the current structure and the content of the template, even if the flexibility and number of options are not sufficient to allow a script language. However compared with a solution, with which Internet pages are generated dynamically using a script language, this solution requires significantly fewer hardware resources, in particular in respect of the capacity of the microprocessor and the size of the main memory required.

The generated Internet page can in principle be in any text format and is preferably such in HTML or XML format, so that it can be displayed graphically just using a browser, without additional software.

The data file can contain a list of variable structures and the template a list of values corresponding thereto. When the template is parsed, the parser replaces the at least one variable structure with its value. The value can be stored in the data file or can be known generally. For example the template can comprise an array of variable structures, for example in the form of a table with rows and columns, and the data file an array of values corresponding thereto. The add-on to the basic Internet page can be configured in a flexible manner by updating the data file and varying the values correspondingly.

The data file and template are preferably XML files and can thus be used across a range of platforms. This reduces maintenance outlay and facilitates deployment among different operating systems. In this manner known parsers for XML files can be accessed, with DOM parsers being particularly suitable due to their high level of user-friendliness. DOM here stands for the XML Document Object Model, a programmable user interface for documents in XML format.

An XML data file and the XML template corresponding thereto are parsed sequentially as usual, it being checked for each XML node or tag whether there is an associated template. If so, the content of the template is processed or parsed fully and its content is written to the output buffer. When the template has been fully parsed, the parser processes the remaining parts of the data file, until this is fully processed.

The data file can also be generated dynamically to show current information, the procedure being such that the data file is only generated when the Internet page has been requested by a third party. This procedure is for example suitable for scanning the status of components of an installation. The data file is generated at the time of the scan, the data file containing a list of all the components connected to the installation or whose status is “ON”. An auxiliary program can be used to generate the data file, being processed by the respective microprocessor. Alternatively the auxiliary program is present in the firmware of the system or in the hardware, for example in an ASIC.

The inventive method is preferably implemented by means of a computer program. The computer program comprises a conventional parser, for example a DOM parser, and an editor to generate a data file and a template. The editor is preferably configured to generate data files automatically without manual intervention.

The inventive computer system comprises a microprocessor, main memory and in some instances hard disk storage and is configured to implement the inventive method. To this end it has means to generate the basic Internet page described above, which comprises a static code, and means to generate an add-on for the basic Internet page by parsing the data file and template. The means can be a parser in each instance (it is even possible to use a single parser) or at least one memory module, for example a programmable memory module such as an EPROM or an ASIC.

### BRIEF DESCRIPTION OF THE DRAWINGS

The invention is described in more detail below based on an exemplary embodiment in conjunction with the figures and annexes, in which:

FIG. 1: shows a schematic overview of a first variant of the method,

FIG. 2: shows a schematic overview of a second variant of the method,

FIG. 3: shows the entire Internet file, displayed using an Internet browser,

FIG. 4: shows a computer system to execute the method.

### DETAILED DESCRIPTION OF INVENTION

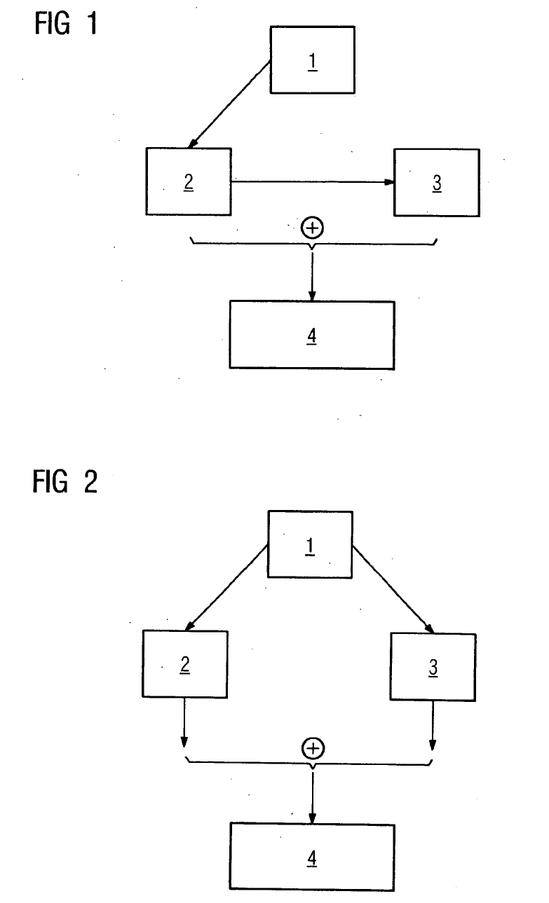

FIG. 1 shows a schematic diagram of the sequence of the first variant of the inventive method. A basic Internet page 1 links to a data file 2, which in turn links to a template 3. An add-on 4 to the basic Internet page 1 is provided by parsing the data file 2 and the template 3.

FIG. 2 shows a schematic diagram of the sequence of the second variant of the inventive method. A basic Internet page 1 links to a data file 2 and a template 3. An add-on 4 to the basic Internet page 1 is provided by parsing the data file 2 and the template 3.

Annex 1 shows a standard HTML page, in which in line 15 the call “ProcessXMLData” links to both a data file and a template. This is because the two arguments of this function call are the name “MainNavigation1.xml” of the data file and the name “MainNavigation2.xml” of the template. An HTML parser is used for parsing, more specifically the one belonging to the MiniWeb browser of the MWLS server marketed by the applicant. The parser parses the first 14 lines of the HTML page and then starts to parse the data file shown in annex 2 and the template shown in annex 3.

The data file for example defines a number of buttons for navigation purposes shown on the Internet page to be displayed. The buttons are shown in block 5 in FIG. 3 and are labeled “Entrance”, “Variables”, WebServices”, “Trace” and “VarSimulator”. The further content shown in FIG. 2 of the Internet page displayed with the Microsoft Internet browser is largely of no interest and is therefore not shown on the basic Internet page for the purposes of simplification.

In the template it is defined in lines 9 and 10 that buttons are to be generated for the main menu. The variable “NAME” is used to locate the writing on the button, with the variable being assigned a value in line 12, said value for its part being the value “Entrance” in the data file according to annex 2. Agreements relating to how the system is to respond when a mouse pointer is moved to the button appear in lines 13 to 15.

The basic HTML Internet page according to annex 1 is supplemented with a dynamic element by the parsing processes. The dynamic element is shown in block 5 in FIG. 3. Buttons generated by way of the data file and template are disposed side by side in this block 5.

FIG. 4 shows a computer system with the actual computer 1, a screen 2, a keyboard 3 and a mouse 4. The system has a means 5 in the form of an ASIC to provide a basic Internet page comprising static code. A further means 6 in the form of a further ASIC is used to generate an add-on for the basic Internet page by parsing a data file and template. In an alternative embodiment just one ASIC is provided to generate the basic Internet page and its dynamic add-on.

Annex 1: shows a basic Internet file in HTML format,

Annex 2: shows a data file in XML format, to which the basic Internet file according to annex 1 links,

Annex 3: shows a template in XML format, to which the basic Internet file according to annex 1 and the data file according to annex 2 link.

Annex 1: Example of a basic Internet page

<html>

<head>

<title>

MiniWeb Main Navigation

</title>

</head>
<link rel=“stylesheet” type=“text/css”
href=“/CSS/MiniWeb.css”></link>
<script language=“JScript” src=“/Scripts/Portal.js”></script>
<body class=“PORTAL” style=“{height = ‘22px’; top = ‘0px’ ;
margin-

top=‘0px’}”>

<table>

<tr>

<!-- <MWSL> ProcessXMLData(<EXTERNAL

SRC=“/XML/MainNavigation1.xml”/>,
<TEMPLATES><EXTERNAL

SRC=“/Templates/MainNavigation2.xml” /></TEMPLATES>)
</MWSL>-->

</tr>

</table>

</body>

</html>

Annex 2: Example of a data file

<?xml version=“1.0” standalone=“yes”?>
<MAINNAVIGATION>

| | |
|---|---|
| <APPLICATION NAME | = “Entrance” |

CLIENTAREA = “/Portal/Entrance.html”
TITLE = “Back to Entrance Page.” />

| | |
|---|---|
| <APPLICATION NAME | = “File Browser” |

SECUREGROUP = “File Administrator”
CLIENTAREA = “/www”
TITLE = “Browse the Filesystem” />

| | |
|---|---|
| <APPLICATION NAME | = “Variables” |

CLIENTAREA = “/%(Accept-Language(HTTP)%)/

TestVar.html”

| | |
|---|---|
| TITLE = “Shows Read and write access to | system |

variables”/>

| | |
|---|---|
| <APPLICATION NAME | = “SystemTest” |

SECUREGROUP = “Test”
CLIENTAREA = “/SystemTest/SystemTest.html”
TITLE = “Performs some system tests on the MiniWeb

Server”/>

| | |
|---|---|
| <APPLICATION NAME | = “WebServices” |

CLIENTAREA = “/WebServices”
TITLE = “WebServices Demonstrations”/>

| | |
|---|---|
| <APPLICATION NAME | = “Configuration” |

SECUREGROUP = “FileAdministrator”
CLIENTAREA = “/Configure.html”
TITLE = “Load a new configuration to the
MiniWeb server.”/>

| | |
|---|---|
| <APPLICATION NAME | = “Trace” |

CLIENTAREA = “/TRACE/GetDebugBuffer”
TITLE = “Starts the Debug Tracer.”/>

| | |
|---|---|
| <APPLICATION NAME | = “CSSA” |

SECUREGROUP = “User”
CLIENTAREA = “/CSSA/Main.html”
TITLE = “PKI Interface.”/>

| | |
|---|---|
| <APPLICATION NAME | = “VarSimulator” |

CLIENTAREA = “/Simulator/Simulator_index.html”
TITLE = “Simulate several variables.”/>

</MAINNAVIGATION>

Annex 3: Example of a template file

<?xml version=“1.0” standalone=“yes”?>
<TEMPLATES>

<TEMPLATE NAME=“APPLICATION”>

<POSITION NAME=“LINE”>

<![CDATA[

<td>

<input class = “MainMenu”

type = “BUTTON”
title = “<MWSL>TITLE</MWSL>”
value = “<MWSL>NAME</MWSL>”
OnClick = “NavigateApp(‘<MWSL>CLIENTAREA</MWSL>’)”
OnMouseOver = “window.status=‘<MWSL>TITLE</MWSL>’”
OnMouseOut = “window.status=‘MiniWeb Client Workbench’” />

</td>

]]>

</POSITION>

</TEMPLATE>

</TEMPLATES>

1-12. (canceled)

13. A method for generating Internet pages using an embedded system in the field of automation, comprising:
providing a basic Internet page comprising static code;
linking the basic Internet page to a data file;
linking the data file to a template; and
generating an add-on for the basic Internet page by parsing the data file and the template.

14. A method as claimed in claim 13, wherein the basic Internet page is directly linked to the template and the data file.

15. A method for generating Internet pages using an embedded system in the field of automation, comprising:
providing a basic Internet page comprising static code;
linking the basic Internet page to a data file;
linking the basic Internet page to a template; and
generating an add-on for the basic Internet page by parsing the data file and the template.

16. The method as claimed in claim 13, wherein the Internet page is generated in a HTML or a XML format.

17. The method as claimed in claim 16, wherein the data file contains a list of variable structures and the template contains a list of values corresponding to the variable structures.

18. The method as claimed in claim 17, wherein the list of variable structures is table with rows and columns, and the data file is a corresponding array of values.

19. The method as claimed in claim 16, wherein the data file and the template are XML files.

20. The method as claimed in claim 19, wherein there is a check for every XML node whether there is an associated template to the basic Internet page.

21. The method as claimed in claim 20, wherein it is checked whether the template is fully processed, if a template associated.

22. The method as claimed in claim 16, wherein the template has at least one variable structure, and during generation of the add-on of the variable structure the value of the variable structure is replaced by a value stored in the data file.

23. The method as claimed in claim 16, wherein the Internet page is only generated when requested by a third party.

24. The method as claimed in claim 23, wherein the data file is generated when a third party requests the Internet page and subsequently the add-on to the Internet page is generated.

25. A method as claimed in claim 13, wherein the method is performed by a computer program.
